(19) United States
(12) Patent Application Publication
(10) Pub. No.: US 2001/0042107 A1
(43) Pub. Date: Nov. 15, 2001

(54) Networked audio player transport protocol and architecture

(76) Inventor: Stephen R. Palm, Fullerton, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/755,085

(22) Filed: Jan. 8, 2001

Related U.S. Application Data
(60) Provisional application No. 60/174,706, filed on Jan. 6, 2000.

(51) Int. Cl. G06F 15/16

(52) U.S. Cl. 709/218; 709/219; 709/231

(57) ABSTRACT

The present invention contains a communications system consisting of a networked multimedia device (also referred to as a multimedia player) and a media server that may be located within a home network or an external network. Further it contains a method for selecting and delivering multimedia. Specifically, the instant invention focuses on solutions for multimedia content delivery from a centralized repository, via the home-networking infrastructure, to IP based multimedia devices, which are connected to that same network.

### CROSS-REFERENCE TO RELATED APPLICATIONS

This application claims priority under 35. U.S.C. § 119 (e) to provisional application 60/174,706 filed Jan. 6, 2000 incorporated in its entirety herein by reference.

### BACKGROUND OF THE INVENTION

1. Field of the Invention

The present invention is directed to a communications device and system, and a method for deploying home-networking based multimedia delivery solutions. Specifically, the instant invention focuses on solutions for multimedia content delivery from a centralized repository, via the home-networking infrastructure, to IP based multimedia devices, which are connected to that same network.

2. Background Art

The recent proliferation of high speed home networking technologies (e.g. phone wire based, wireless, power-line, etc) combined with the deployment of broadband internet access (e.g. xDSL, cable modems, satellite, wireless, etc) encourages and provides a foundation for consumers to listen to and view digital multimedia content. On one hand, users of computers have been able to play digital media content on their computer, but it has required detailed knowledge of operating systems and application programs. On the other hand, devices such as televisions and radios have extremely simple and user friendly interfaces but are generally limited to receiving non-interactive broadcast programming. From the consumer user perspective, what is needed are receiving devices (players) with relatively simple to operate user interfaces in which they can interactively select content stored on media servers that is delivered via their home network.

From the system design perspective, protocols and interfaces are needed to provide communication between the user player and media server so that the user may navigate and select the particular media items to be played. Once the user has made their selection, a format for describing the pieces of content, the ordering of play, and other information must also be communicated between the server and the player before the transmission of the actual media.

### BRIEF SUMMARY OF THE INVENTION

The present invention contains a communications system consisting of a networked multimedia device (also referred to as a multimedia player) and a media server that may be located within a home network or an external network. Further it contains a method for selecting and delivering multimedia. Specifically, the instant invention focuses on solutions for multimedia content delivery from a centralized repository, via the home-networking infrastructure, to IP based multimedia devices, which are connected to that same network.

The present invention utilizes HTML and WML to optimize for playlists and media headers. Usable home network media include, but are not limited to, phone wire based, wireless, power-line, etc. Usable broadband Internet access media include xDSL, cable modems, satellite, wireless, etc. The invention provides consumer user receiving devices (multimedia devices or players) with relatively simple to operate user interfaces in which they can interactively select content stored on media servers that is delivered via their home network.

The present invention provides protocols and interfaces for communication between the multimedia devices and media server so that the user may navigate and select a particular media item to be played. The invention also allows communication either with at least one local media server (content repository) and media servers on the Internet. Users are provided the ability to type a few letters and see the possible completions after each letter is typed since a unique match may be reached without typing the full letters of the keyword. This is especially important since the present invention contemplates multimedia devices that do not have a full size keyboard.

One feature of the invention is that once the user has made their selection, it provides a format for describing the pieces of content, the ordering of play, and other information that must be communicated between the server and the player before the transmission of the actual media.

Another feature of the invention, is that it provides a method to allow the user many different ways of indicating their preferences such as, but not limited to selection from a hierarchical list, searches, both interactive and submitted, content provider suggestions, etc.

An advantage of the instant invention is that it provides an interactive search by processing a database of track, album, and playlist information.

### BRIEF DESCRIPTION OF THE DRAWINGS/FIGURES

The present invention is described with reference to the accompanying drawings. In the drawings, like reference numbers generally indicate identical, functionally similar, and/or structurally similar elements. The drawing in which an element first appears is indicated by the left-most digit or digits in the corresponding reference number. The accompanying figures, which are incorporated herein and form part of the specification, illustrate the present invention and, together with the description, further serve to explain the principles of the invention and to enable a person skilled in the relevant art to make and use the invention.

FIG. 1 illustrates an example of a home-network based multimedia delivery system according to an embodiment of the present invention.

FIG. 2 illustrates a multimedia device user interface according to an embodiment of the present invention.

FIG. 3 is a flowchart diagram of a routine for delivering multimedia clips over a home-network according to an embodiment of the present invention.

FIG. 4 illustrates an implementation of a home-network based multimedia delivery system user interface according to an embodiment of the present invention.

### DETAILED DESCRIPTION OF THE INVENTION

The detailed description of the present invention that follows begins with a terminology subsection that defines terms used to describe the invention. This subsection is then followed by subsections that describe in detail various embodiments of the invention. Finally, this section concludes by illustrating an implementation of the present invention.

Terminology

The following terms are defined so that they may be used to describe embodiments of the present invention. As used herein:

Multimedia clip means electronic audio or video data. A typical multimedia clip might have all or a portion of a song, an entire album recording, streaming stereo channel data, or other information as known to a person skilled in the relevant arts.

SDMI refers to Secure Digital Music Initiative

WAP refers to Wireless Access Protocol

WML refers to Wireless Markup Language

RDBMS refers to Remote Database Management System

References

The detailed disclosure also refers to the following Recommendations, Standards, drafts and contributions, the subject matter of which is expressly incorporated herein by reference in their entirety:

[SSDP] Y. Goland, T. Cai, P. Leach., Y. Gu, S. Albright, “DRAFT Simple Service Discovery Protocol/1.0”, http://www.ietf.org/internet-drafts/draft-cai-ssdp-v1-03.txt

[DHC] R. Troll, “DRAFT Automatically Choosing an IP Address in an Ad-Hoc IPv4 Network”, http://www.ietf.org/internet-drafts/draft-ietf-dhc-ipv4-autoconfig-04.txt

[HTTPUDP] Y. Y. Goland. Multicast and Unicast UDP HTTP Requests. Internet Draft—a work in progress, draft-goland-http-udp-00.txt.

[RFC2365] D. Meyer. Administratively Scoped IP Multicast. RFC 2365, July 1998.

[RFC2396] T. Berners-Lee, R. Fielding and L. Masinter. Uniform Resource Identifiers (URI): Generic Syntax. RFC 2396, August 1998.

[HTTP] R. Fielding, J. Gettys, J. C. Mogul, H. Frystyk, L. Masinter, P. Leach and T. Berners-Lee. Hypertext Transfer Protocol - HTTP/1.1. RFC 2616, November 1998.

[ASX] http://msdn.microsoft.com/workshop/imedia/windowsmedia/crcontent/asx.asp

[SDMI] http://www.sdmi.org

System Requirements

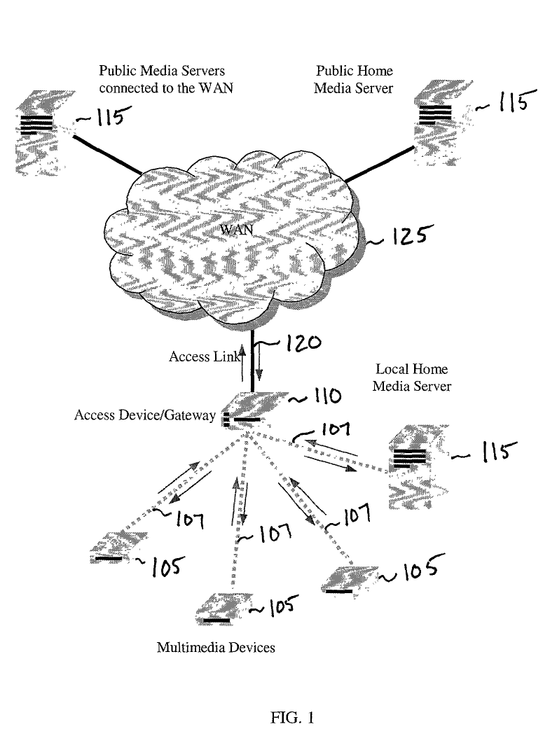

FIG. 1 illustrates an example home-network based multimedia delivery system 100 according to an embodiment of the present invention. Home-network based multimedia delivery system 100 is comprised of at least one multimedia device 105, at least one media server 115, and a local home communications network 107. Home-network based multimedia delivery system 100 is further comprised of an access gateway 110, an access link 120, and a public communications network 125. Each of these features of home-network based multimedia delivery system 100 is further described below.

Multimedia devices 105 are connected via the local home communications network 107 to a media server 115. Local home communications network 107 can be implemented using any two-way networking technology such as telephone wire, for example. Multimedia devices 105 can be further connected to other media servers 115 via access link 120. Access link 120 can also be implemented using broadband networking technology such as wireless, and power-line xDSL, cable, and satellite for example.

Access Device/Gateway 110 serves as an interface between a local home communications network 107 and an access link 120. Access Device/Gateway 110 is able to translate communications protocols necessary to allow communications between a local home communications network 107 and an access link 120. In one embodiment, access link 120 is used to facilitate communications between multimedia device 105 and media servers 115 located on public communications network 125. In this case, access device/gateway 110 is further used to translate communications protocols used to communicate over public communications network 125 into communications protocols used to communicate over the local home communications network 107. In one embodiment, Access Device/Gateway 110 is further able to allocate an IP address for media device 105.

Media server 115 can be any processor capable of accepting requests using HTTP (or WAP, or other equivalents for broadband wireless) for content catalog browsing as well as media streaming. The media server 115 may respond to each request with a response which complies with the WML standard, in which case the multimedia device 105 will render it accordingly to obtain the next request from the user interface, or with a response which denotes a multimedia object to be retrieved by the device (e.g. an MP3 clip).

In one embodiment, media server 115 is comprised of a storage medium for the media content, i.e. multi media clips, and an indexing engine that contains pointers to content location (e.g. RDBMS) and any additional information associated with the content. In a preferred embodiment, the content provider will also implement the content grouping into categories such as rock, country, and rhythm and blues for example. The media server 115 further comprises an application server (not shown), which dynamically generates the WML content and the XML scripts describing the play lists based on the multimedia device's requests, an HTTP server (not shown) to which the multimedia device is connected, and an optional mechanism for authenticated multimedia device access (not shown).

It is the responsibility of the media server 115 to compose play list descriptor files or scripts. This task is accomplished using dynamic generation of those scripts, in accordance with the specification provided herein. It is the multimedia device's 105 responsibility to parse those scripts, and issue corresponding calls to the media server 115 to retrieve the content specified in them.

Media server 115 can reside in the local home communications network 107 or on public communications network 125. Public communications network 125 can be any publicly accessible wide area network such as the Internet for example. Regardless if the media server 115 resides in the vicinity of the home or office, or at some Data Center on the Internet, it provides a uniform functionality, which to the multimedia device appears transparent through the simple WML script, which is used to render the screens at multimedia device 105. In general, the media server's 115 role is similar to one of a web server: to allow the multimedia device 105 to navigate through a set of screens which describe the media titles, or the play lists, and to access the content in a direct access fashion for playback purpose. Clever content providers and aggregators should be able to leverage this capability and insert additional content such as advertising and branding messages into the actual content or to the menus. Others (typically portals) can use this to link multiple media servers 115 to each other, thus providing a ring of content servers, which appear to the multimedia device 105 as one entity.

Multimedia devices 105 should however be able to function without the presence of a media server 115 within the local home communications network 107, thereby allowing media servers 115 outside the scope of the local home communications network to function as alternative media servers 115. It is assumed that some devices may ship out-of-the-box with the ability to directly connect with media servers 115 attached to the public communications network 125.

The IP addresses for media servers 115 connected to the local home communications network are published on the network using a method based on DHCP as described further below. In addition, as evident from FIG. 1, multimedia devices 105 are able to issue similar requests to Media Servers outside the scope of the local home communications network. In similarity to ordinary Web browsing, initial access to a media server 115 will be obtained by specifying a URL which also may be supplied via DHCP. In one embodiment, the media server 115 located inside the local home communications network 107 will be used to locate the media servers 115 on the public communications network 125.

With the above assumptions, the actual application on the Multimedia Device remains generic, and it is up to the Media Server's implementation to define the functionality, as long as the implementation remains within the constraints of the WML language and the capabilities of the device requesting the information.

In one embodiment, multimedia device 105 is further able to automatically configure itself on local home communications network 107. Automatic configuration of the multimedia device 105 on the local home communications network 107 can be done using a method such as DHCP. The implementation of DHCP would be apparent to one skilled in the relevant art and thus further detail is not necessary. However, the DHCP method is further described in the article “Automatically Choosing an IP Address in an Ad-Hoc IPv4 Network” [DHC] incorporated herein in its entirety. Multimedia device 105 is able to resolve a host name in a URL using DNS call. Multimedia device 105 is further able to issue HTTP requests (GET, POST) [HTTP] and receive HTTP responses containing MIME classified objects. Multimedia device 105 is further capable of at least displaying Wireless Markup Language compatible (WML) or HTML content.

Multimedia device 105 is also able to parse a play list, containing URLs of specific clips, in XML format. Finally, multimedia device 105 is capable of mixing remote (song title, total length, advertisements, etc) content and local (elapsed time, eye candy (spectral analyzer, etc) content.

In another embodiment, multimedia device 105 is capable of connecting to a media server 115 using either local home communications network 107 or public communications network 125.

In still another embodiment, multimedia device 105 is further capable of supporting interactive search by processing a database of track/album/playlist information.

In yet another embodiment, multimedia device 105 is further capable of receiving “channels” designated by number. This functionality is equivalent to television or radio where the user selects a channel number and receives a broadcast if available. Since this implies multipoint (non-interactive) reception, the receiver must be capable of starting playback in mid stream (ie no header information describing the contents ) (e.g. MS Netshow .nsc file)

A preferred embodiment includes all the features described above.

However, it is contemplated that other embodiments may include any subset of these features. Further, while the present invention is described with reference to audio (i.e, digital audio files and stereo for example), this is intended by way of example only and not limitation. It is contemplated that graphics and video will be accessed as well.

Functionality

The introduction of the above capabilities for home networking multimedia device 105 will allow it to perform the following sample functions against a centralized repository of multimedia clips stored in media server 115:

1. Navigate through the content repository's logical hierarchy of media categories;

2. Request and display play lists;

3. Passive Search for specific titles using keywords (in title, artist, playlist name, etc) (Optional);

Request a specific title for playback,

Request scheduled or non-scheduled interruptions for the purpose of aborting the current media title (if any), to switch to another, and

4. Interactive Search for specific titles using keywords (in title, artist, playlist name, etc) (Optional).

The interactive search may function on the first word of a text string or all words in a text string. As the user is entering a search text string, each character is read by multimedia device 105 and compared to a local information store representative of all the available multimedia clips. Based on this comparison, multimedia device 105 is able to anticipate what the user intends to request. For example, if the user is interactively searching by artist, typing the letters “P” “R” may match with “PRince”, “The PRetenders”, “Elvis PResley” and “Bruce SPRingsteen”.

Sample Multimedia Devices

Multimedia device 105 is a receiving device, such as a set-top box for example, able to process digital audio, video, graphics, or similar data. Described below are the input and display mechanisms associated with the multimedia device. In a preferred embodiment, the multimedia device is capable of playing audio signals or transmitting the audio or video signals to an external device (e.g., speakers or video screen).

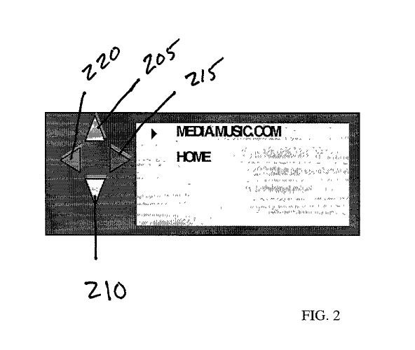

In an embodiment, multimedia device 105 implements WMLbrowsing for the purpose of navigating through a catalog containing MP3 clips. Referring to FIG. 2, the multimedia device 105 in this embodiment is provided with a graphical user interface that has the capability of displaying four lines of text containing up to 25 characters. Alternatively, multimedia device 105 could be connected to a television display, PC monitor, PDA, or similar display device. In addition, the multimedia device 105 is capable of playing back MP3 content (e.g. Live feeds) directly off the Internet. The purpose of this example is to show that WML browsing and MP3 playback over HTTP are sufficient enough to implement a fully-fledged MP3 player, since most of the menu generation is the responsibility of the media server 115.

The navigation capabilities of the multimedia device 105 include the following:

Up button 205 and Down button 210 (scroll): to navigate forward/backward to the next hyperlink in the content page;

a Select button 215: to select the hyperlink and fetch the next object specified in the hyperlink; and

a Back button 220: to return to the previous page.

In an alternative embodiment, multimedia device 105 is provided with a 14-key input means and 4X25 character output means. This multimedia device 105 has essentially the same display as the previous example, but the user interface has approximately 14-keys instead of 4-keys. To make interactive search possible, it is assumed that at least 14-keys are needed. These keys include the 4-keys described above in the previous embodiment plus 10 keys that are primarily used as “digits” but also overlay alphabetical input in a manner similar to telephone keypads: 2-“ABC, 3-“DEF””, etc.. When the user has navigated to an interactive search mode, the partial keyword lookup can be in the category of artist, title, playlist name, etc..

In yet another embodiment, multimedia device 105 is provided with a 4/14-key input means and a PIXEL Addressable (Small) output means. For example, multimedia device 105 could be a handheld PC, pen-input based device, or similar class device that might be running an operating system such as WinCE or PalmOS. One skilled in the relevant arts would recognize that no special requirements are needed, as this embodiment should be able to support HTML and all other necessary protocols.

In another embodiment, a multimedia device 105 is provided with an input method that can be varied. In this embodiment output is pixel addressable, so the transport protocol must allow graphical data such as pixmaps. According to this embodiment, a full keyboard is used for input and output is PIXEL addressable (Medium to large). For example, multimedia device 105 could be a PC or similar class device. One skilled in the relevant arts would recognize that no special requirements are needed, as this embodiment should be able to support HTML and all other necessary protocols.

GUI Display

In all of the example embodiments of multimedia device 105 above, a means is needed to display content transmitted by the media server 115 (lists, titles, etc) with content generated locally on the client (elapsed time, eye candy, etc). In the traditional HTML environment, client side scripting (eg JavaScript) is frequently used to mix local information with the information transmitted by the server. Client-side script statements embedded in an HTML page can respond to user events such as mouse-clicks, form input, and page navigation. The script statements are needed to respond to system events (e.g. elapsed timer variable updating, spectrum bitmap updating, etc) as well. The script statements execute without any network transmission (after their initial download with the page). The WAP forum has standardized WML script as a simpler version of JAVA Script (ECMA script) that can be used in combination with WML and WAP.

Implementation

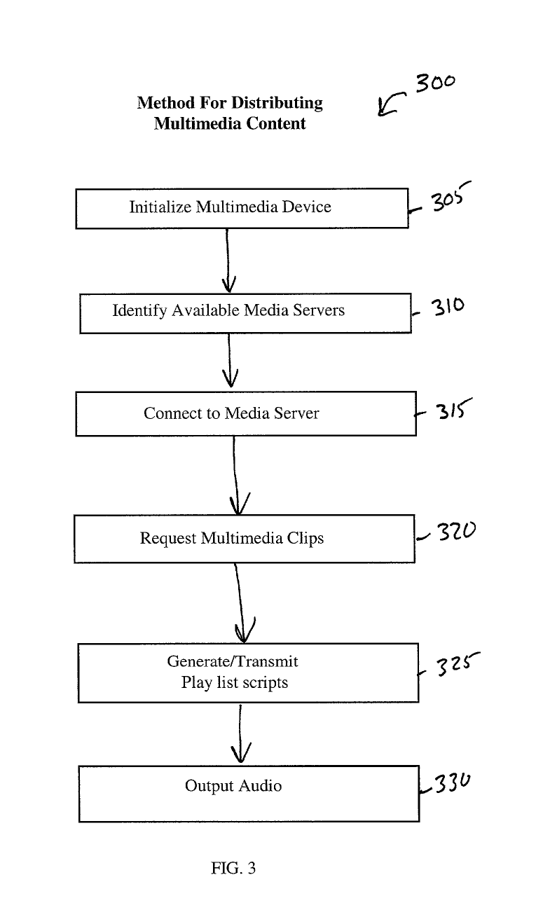

A method 300 for providing multimedia content over a network will now be described with reference to FIG. 3. In a step 305, multimedia device 105 is initialized. In an embodiment, the multimedia devices 105 follow the guidelines proposed by UPnP. In brief, initial setup for multimedia device 105 consists of requesting an IP setup configuration via DHCP, with the Auto-Configuration option. After the address is assigned, the client should test if the address is not conflicting, and try again until all retries are exhausted.

After the device is booted and is assigned with an IP address, in step 310, the device will identify and display all discovered Media Servers 115 available to provide multimedia content. Some of the media servers 115 on the list may be pre-defined in multimedia device's 105 built in configuration by the manufacturer. The multimedia device 105 will attempt to connect to the media server 115. Certain devices will attempt to connect to media server 115 using a DNS call to the name server assigned during the DHCP session, which will, in turn, return the address of a media server 115 connected to the public communications network 125. In addition, the device will attempt to discover more media servers 115 within the vicinity of the local home communications network 107 using the SSDP discovery method or equivalent.

In step 315, multimedia device 105 connects using HTTP to a selected media server 115 and retrieves the default home page. In an embodiment, the default home page will include a description of what media clips are available from media server 115. Media clips can be video, audio, graphics, or other data capable of being digitized and downloaded across a network.

Next, in step 320, multimedia device 105 is used to request a specific multimedia clip from media server 115. The user may request to play an entire list of songs arranged in play lists (typically albums) in their original order or in random order, or individual songs. The lists and the songs they contain depend on how the media was arranged in media server's 115 song repository.

When the user selects to play a song or a list of songs, in step 325, a play list is generated and transferred from the media server 115 to the multimedia device 105 using an XML script, which contains all the information, required by the player to playback the list. Play list description scripts are XML files containing a list of files, which are to be played by multimedia device 105. The script can contain additional information per clip, such as graphics, copyright message and title description. This proposal has some similarities to the Microsoft ASX file format, which is derived from XML. The play list file will have the following MIME type registered: application/x-brcm-hnm (where ‘hnm’ stands for ‘Home Networking Media’). This MIME type is to be registered as a certified IETF MIME type.

Finally, in step 330, the play list is received by multimedia device 105 and parsed such that an audio output is generated.

The following sample file contains two clips, which are to be played back-to-back one after another:

<HNM version = “1.0”>
<TITLE>Simple Play List</TITLE>
<ENTRY>

<TITLE>This is the first clip</TITLE>
<AUTHOR>Broadcom Corporation</AUTHOR>
<COPYRIGHT>(c) 1999 Broadcom Corporation</COPYRIGHT>

<REF HREF = “http://media.broadcom.com/samples/sample1.mp3” />
</ENTRY>
<ENTRY>

<TITLE>This is the second clip</TITLE>
<AUTHOR>Broadcom Corporation</AUTHOR>
<COPYRIGHT>(c) 1999 Broadcom Corporation</COPYRIGHT>

<REF HREF = “http://media.broadcom.com/samples/sample2.mp3” />
</ENTRY>
</HNM

Multimedia device 105 should support at least the <REF> tag.

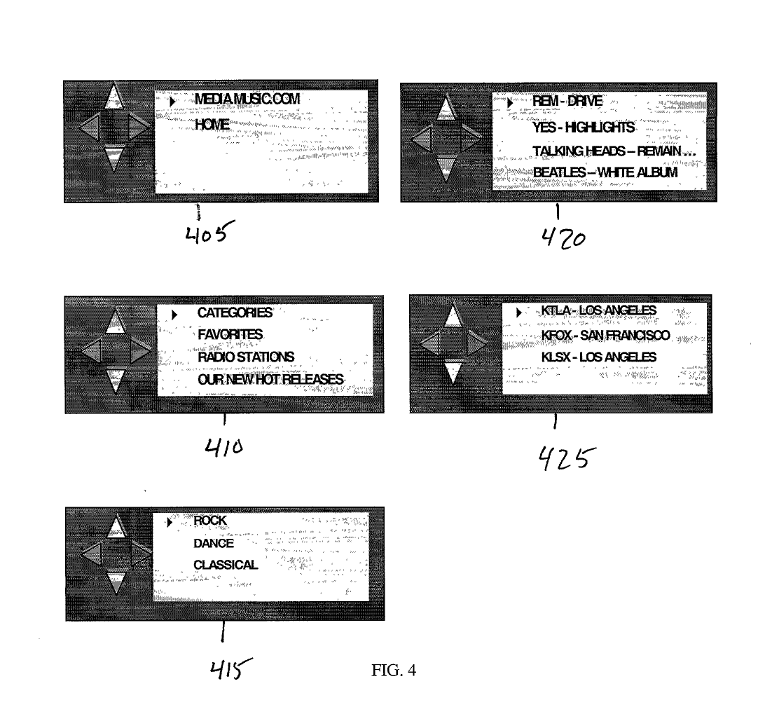

Implementing extended tags (such as copyright, logo etc) is optional and depends on the capability of the player. More information about ASX file formats can be found in reference [ASX]. Implementation of the method 300 will now be described with respect to FIG. 4.

In step 405, multimedia device 105 has been initialized and the available media servers 115 displayed.

In step 410, the default home page for the media server 115 is presented. Here, the user is given a number of options for how selectable multimedia clips are to be presented. Selecting “categories” will issue a command for the media server 115 to fetch the list of categories, resulting in a new document, which lists the existing categories available for browsing.

Next, in step 415, the user is able to scroll to a particular category. Scrolling down beyond the last visible item will result in the screen scrolling up. When the last item is reached, the screen should scroll to the initial position in a cyclic fashion, and the first item should be selected. The method of displaying the selected item is device specific.

Next, in step 420, the user is presented with a song list corresponding to the selected category. When the user selects a song or list of songs to play, the play list will be transferred to multimedia device 105 where it will be played.

In a similar manner, step 425 demonstrates that multimedia device 105 should be able to display Radio Stations defined by the media server 115 as well. In this case, continuous stereo is channeled to multimedia device 105 until a subsequent request is made.

One skilled in the relevant arts would recognize that a particular multimedia clip need not reside on any one particular media server 115. To summarize, via this relatively simple display and navigation tool, the user may move from one media server 115 to another seamlessly, accessing media servers 115, and content stored in them, located within the local home communications network 107 and on the public communications network 125.

Controlled Content Access

In some cases, and to protect content from unauthorized access, the content provider should be able to limit access to its media server 115 repository only to authorized multimedia devices 105.

In one embodiment, multimedia device 105 is only allowed access to the media server 115 after completing a registration phase (e.g. over the phone, email or from the WWW). After the device has been properly registered, the IP address of the device, the IP of the firewall protecting the local home communications network, or the subnet mask of that network should be added to the access list of the media service.

In an alternative embodiment, secured access using HTTPS, using an authorized client-based authentication certificate is used.

Still further, SDMI based approaches [SDMI] or any other proprietary authentication method implemented in the device, which is recognized by the content provider's server as an authorized device could be used.

Conclusion

Various embodiments of the present invention have been described above. It should be understood that these embodiments have been presented by way of example only, and not limitation. It will be understood by those skilled in the relevant arts that various changes in form and details of the embodiments of the present invention as described above may be made without departing from the spirit and scope of the present invention as defined in the claims. Thus, the breadth and scope of the present invention should not be limited by any of the above-described exemplar embodiments, but should be defined only in accordance with the following claims and their equivalents.

What is claimed is:

1. A method for providing multimedia content over a network, comprising the steps of:
(a) connecting at least one multimedia device to at least one media server storing a plurality of selectable multimedia clips over a communications network;
(b) selecting at least one of said plurality of selectable multimedia clips for playing by said at least one multimedia device;
(c) generating a playlist wherein said selected at least one of said plurality of selectable multimedia clips is included therein;
(d) transferring said generated playlist from said selected media server to said at least one multimedia device; and
(e) rendering said playlist.

2. The method of claim 1 wherein said communications network is a local home communications network.

3. The method of claim 1 wherein said communications network is a public communications network.

4. The method of claim 1 wherein said public communications network is the Internet.

5. The method of claim 1 wherein said playlist file comprises audio data.

6. The method of claim 1 further comprising the steps of:
(e) displaying a list of said media servers available to said at least one multimedia device; and
(f) selecting one of said media servers from said list of said media servers available to said at least one multimedia device.

7. A method for providing multimedia content over a network, comprising the steps of:
(a) displaying a list of one or more media servers storing a plurality of selectable multimedia clips available to one or more multimedia devices;
(b) selecting a media server from said list of one or more media servers;
(c) connecting said one or more multimedia devices to said selected media server;
(d) selecting at least one of said plurality of selectable multimedia clips for rendering by said one or more multimedia devices;
(e) transferring said selected at least one of said stored plurality of selectable multimedia clips from said selected media server to said one or more multimedia devices; and
(f) rendering said selected at least one of said plurality of selectable multimedia clips.

8. A networked based multimedia delivery system comprising:
(a) at least one multimedia device having input means and display means through which a user may request multimedia clips and output means through which requested multimedia clips may be played;
(b) at least one media server in communications with said at least one multimedia device for generating a playlist file containing multimedia clips and providing said playlist file to said at least one multimedia device in response to said user's request for multimedia clips; and
(c) a local home communications network for interfacing said at least one multimedia device with said at least one media server.

9. The networked based multimedia delivery system of claim 8 further comprising:
(d) an access link for connecting said local home communication network to said at least one media server over a public communications network; and
(e) an access gateway for translating communications protocols between said local home communications network and said access link.

10. The networked based multimedia delivery system of claim 9 wherein said public network is the Internet.

11. The networked based multimedia delivery system of claim 8 wherein said playlist is comprised of XML.

12. The networked based multimedia delivery system of claim 8 wherein said multimedia device is designed to
(a) be automatically configured on said local home communications network;
(b) resolve a hot name in a URL using DNS call;
(c) issue HTTP request;
(d) receive HTTP responses containing MIME objects;
(e) display WML and HTML content;
(f) parse said playlist;
(g) interactively search a database of track, album, and playlist information;
(h) mix said playlist with local content; and
(i) receive channels of multimedia clips from said media server.

13. The networked based multimedia delivery system of claim 8 wherein said multimedia device is designed to
(a) be automatically configured on said local home communications network;
(b) issue HTTP request;
(c) receive HTTP responses containing MIME objects
(d) display WML and HTML content;
(e) parse said playlist; and
(f) mix said playlist with local content.

14. A networked based multimedia delivery system comprising:
(a) at least one media server for generating a playlist file from a plurality of centrally stored multimedia clips in response to a user request; and
(b) at least one multimedia device in communications with said at least one media server for generating said user request, wherein said at least one multimedia device is further used to receive and parse said generated playlist file.

15. The networked based multimedia delivery system of claim 14 wherein said generated play list comprises XML.

16. A multimedia device for use in a network based multimedia delivery system comprising:
(a) means for automatically configuring the multimedia device on a communications network;
(b) means for displaying at least one media server in communications with the multimedia device over said communications network, wherein said at least one media server has a plurality of stored multimedia clips;
(c) means for interactively searching said plurality of stored multimedia clips using all or a portion of a text string;
(d) means for passively searching said plurality of stored multimedia clips;
(e) means for requesting at least one of said plurality of stored multimedia clips from said at least one media server;
(f) means for receiving a remotely generated data file from said at least one media server over said communications network, wherein said remotely generated data file is comprised of said requested at least one of said plurality of stored multimedia clips;
(g) means for parsing said remotely generated data file; and
(h) means for displaying said remotely generated data file with local data.
